(19) United States
(12) Patent Application Publication
(10) Pub. No.: US 2021/0136883 A1
(43) Pub. Date: May 6, 2021

(54) COOKING RACK ASSEMBLY

(71) Applicant: Howard Brodale, Ft Worth, TX (US)

(72) Inventor: Howard Brodale, Ft Worth, TX (US)

(21) Appl. No.: 16/669,609

(22) Filed: Oct. 31, 2019

(51) Int. Cl. H05B 6/64

(52) U.S. Cl. CPC H05B 6/6408

(57) ABSTRACT

A cooking rack assembly for cooking food in a microwave oven includes a frame that is positionable in a microwave oven. The frame is comprised of a non-metallic material to inhibit reflecting microwave radiation. A basket is coupled to the frame and the basket is elevated from a floor of the microwave oven when the frame is positioned in the microwave oven. The basket is comprised of a non-metallic material to inhibit reflecting microwave radiation. A food item is positionable on the basket to facilitate the foot item to heat evenly in the microwave oven.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cooking devices and more particularly pertains to a new cooking device for cooking food in a microwave oven.

### (2) Description of Related Art Including Information Disclosed Under 37 CFR 1.97 and 1.98

The prior art relates to cooking devices.

### BRIEF SUMMARY OF THE INVENTION

An embodiment of the disclosure meets the needs presented above by generally comprising a frame that is positionable in a microwave oven. The frame is comprised of a non-metallic material to inhibit reflecting microwave radiation. A basket is coupled to the frame and the basket is elevated from a floor of the microwave oven when the frame is positioned in the microwave oven. The basket is comprised of a non-metallic material to inhibit reflecting microwave radiation. A food item is positionable on the basket to facilitate the foot item to heat evenly in the microwave oven.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a cooking rack assembly according to an embodiment of the disclosure.

FIG. 2 is a left side view of an embodiment of the disclosure.

FIG. 3 is a front view of an embodiment of the disclosure.

FIG. 4 is a bottom view of an embodiment of the disclosure.

FIG. 5 is a perspective in-use view of an embodiment of the disclosure.

### DETAILED DESCRIPTION OF THE INVENTION

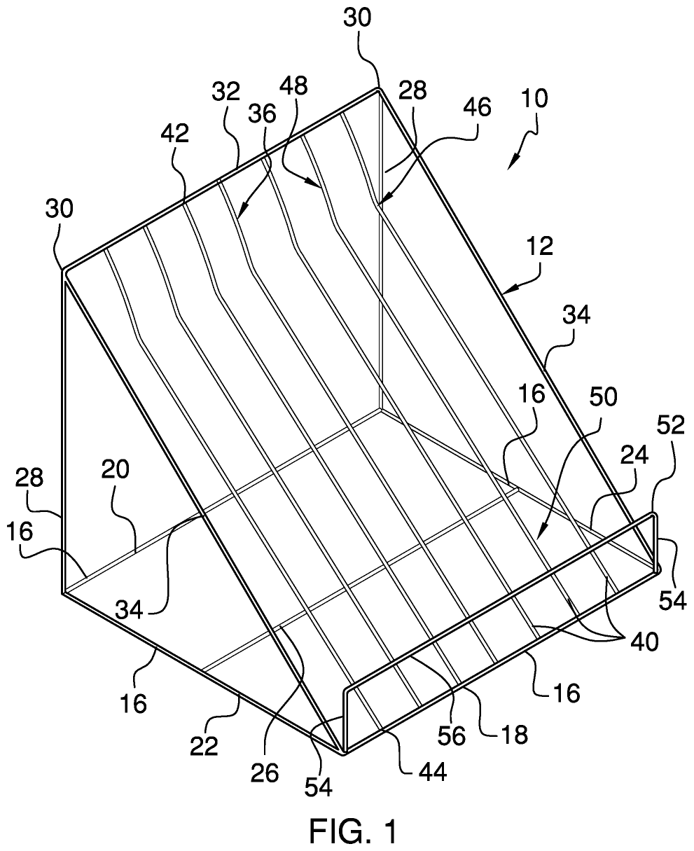

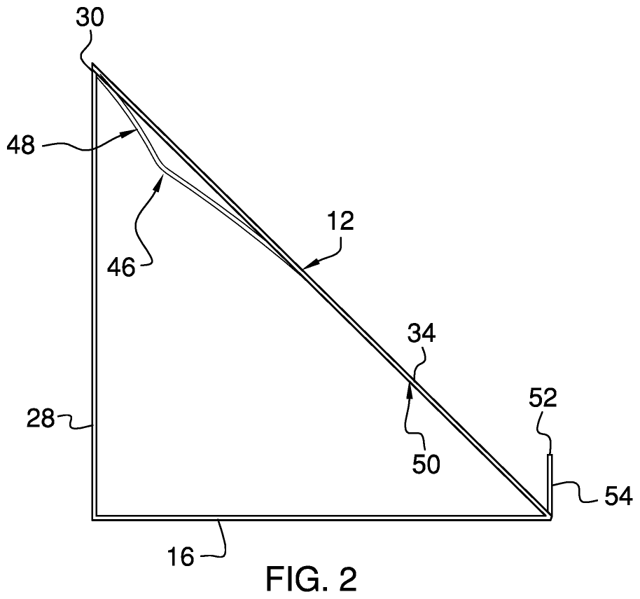

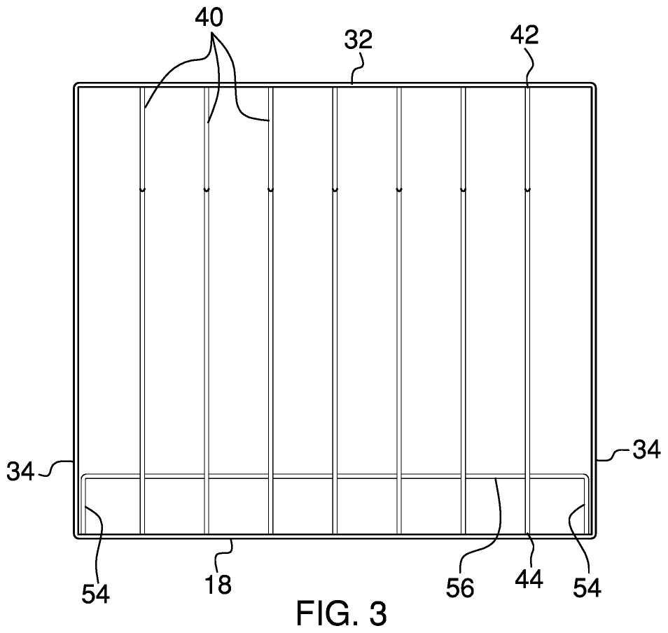

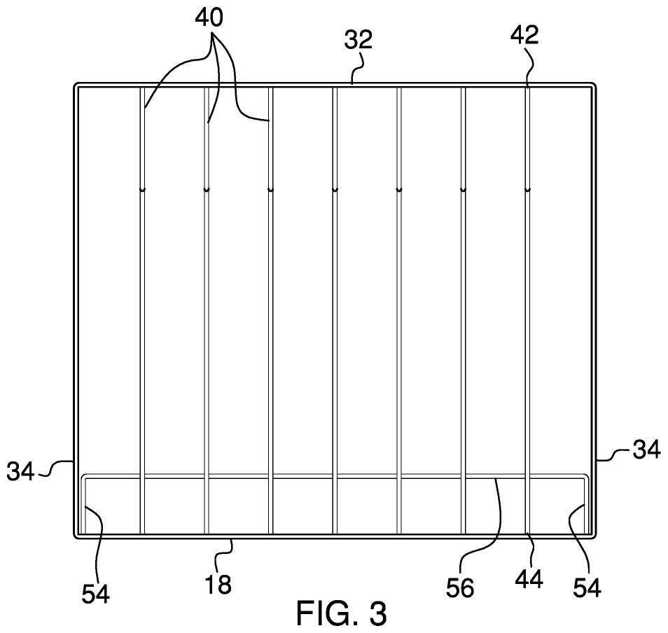

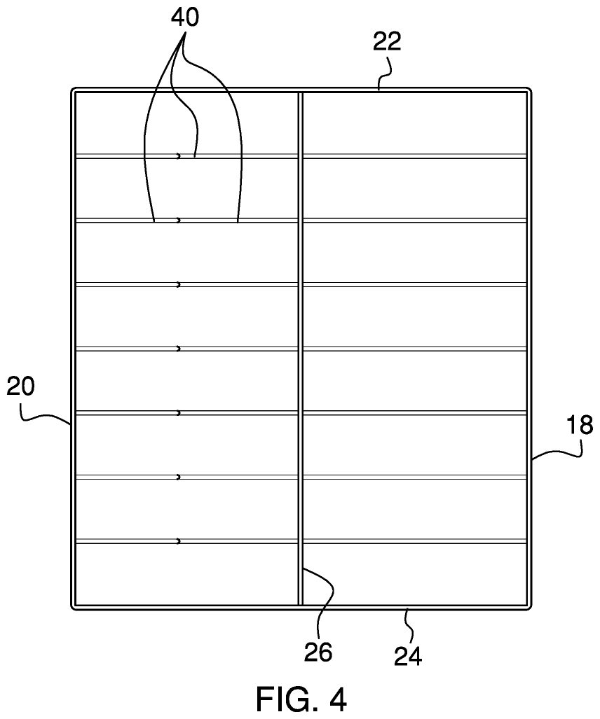

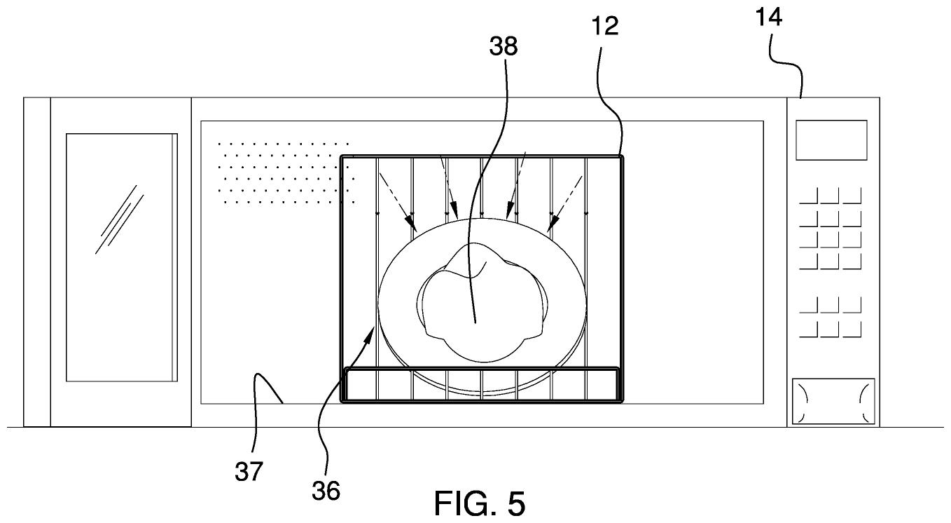

With reference now to the drawings, and in particular to FIGS. 1 through 5 thereof, a new cooking device embodying the principles and concepts of an embodiment of the disclosure and generally designated by the reference numeral 10 will be described.

As best illustrated in FIGS. 1 through 5, the cooking rack assembly 10 generally comprises a frame 12 that is positionable in a microwave oven 14. The frame 12 is comprised of a non-metallic material such that the frame 12 is inhibited from reflecting microwave radiation. In this way the frame 12 can be positioned in the microwave oven 14 while the microwave oven 14 is turned on. The frame 12 comprises a plurality of basal members 16 that is each coupled together and intersecting each other at right angles such that the basal members 16 defines a rectangular shape.

The plurality of basal members 16 includes a front basal member 18, a rear basal member 20, a first lateral basal member 22 and a second lateral basal member 24. The frame 12 includes a central member 26 that extends between each of the first lateral basal member 22 and the second lateral basal member 24. The central member 26 is centrally positioned between the front basal member 18 and the rear basal member 20. The frame 12 includes a pair of upright members 28 that is each coupled to and extends upwardly from the rear basal member 20. Each of the upright members 28 is aligned with opposite ends of the rear basal member 20 and each of the upright members 28 has a distal end 30 with respect to the rear basal member 20.

The frame 12 includes a top member 32 that is coupled to and extends between each of the upright members 28. The top member 32 intersects the distal end 30 of each of the upright members 28 and the top member 32 is oriented collinear with the rear basal member 20. The frame 12 includes a pair of side members 34 that is each coupled between the top member 32 and the front basal member 18. Each of the side members 34 slopes downwardly between the top member 32 and the front basal member 18. Additionally, each of the side members 34 is aligned with a respective one of the first lateral basal member 22 and the second lateral basal member 24.

A basket 36 is coupled to the frame 12 and the basket 36 is elevated from a floor 37 of the microwave oven 14 when the frame 12 is positioned in the microwave oven 14. The basket 36 is comprised of a non-metallic material such that the basket 36 is inhibited from reflecting microwave radiation. In this way the basket 36 can be placed in the microwave oven 14 while the microwave oven 14 is turned on. A food item 38 is positionable on the basket 36 when the basket 36 is positioned in the microwave oven 14. In this way the basket 36 facilitates the foot item to heat evenly in the microwave oven 14.

The basket 36 comprises a plurality of basket members 40 that each has a first end 42 and a second end 44. Each of the basket members 40 has a bend 46 thereon to define a first portion 48 of the basket members 40 forming an angle with a second portion 50 of the basket members 40. The bend 46 is positioned closer to the first end 42 than the second end 44. The first end 42 of each of the basket members 40 is coupled to the top member 32 having the first portion 48 of each of the basket members 40 extending downwardly from the top member 32. The second end 44 of each of the basket members 40 is coupled to the front basal member 18 having the second portion 50 of each of the basket members 40 sloping downwardly between the bend 46 and the front basal member 18. Additionally, the second portion 50 of each of the basket members 40 is spaced upwardly from the floor 37 of the microwave oven 14 when the frame 12 is positioned in the microwave oven 14.

A stop 52 is coupled to and extends upwardly from the front basal member 18 of the frame 12. The stop 52 includes a pair of upright members 54 and a horizontal member 56 extending between the upright members 54. Each of the upright members 54 is aligned with a respective one of the side members 34 of the basket 36 and the horizontal member 56 is spaced upwardly from the front basal member 18. Additionally, each of the upright members 54 extends along a line that forms a 45.0 degree angle with the respective side members 34 of the basket 36. In this way food item 38 rests against the stop 52 when the food item 38 is placed on the basket 36.

In use, the frame 12 is positioned in the microwave oven 14 prior to cooking the food item 38 in the microwave oven 14. The food item 38 is positioned on the basket 36 to elevate the food item 38 upwardly from the floor 37 of the microwave oven 14. In this way the food item 38 can be evenly cooked in the center of the food item 38 as well as along the edges of the food item 38. Additionally, the frame 12 and the basket 36 do not reflect microwave radiation thereby facilitating normal operation of the microwave oven 14 for cooking.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking rack assembly being configured to elevate food being cooked in a microwave oven, said assembly comprising:
a frame being positionable in a microwave oven, said frame being comprised of a non-metallic material wherein said frame is inhibited from reflecting microwave radiation;
a basket being coupled to said frame, said basket being elevated from a floor of the microwave oven when said frame is positioned in the microwave oven, said basket being comprised of a non-metallic material wherein said basket is inhibited from reflecting microwave radiation, said basket having a food item being positionable thereon wherein said basket is configured to facilitate the foot item to heat evenly in the microwave oven.

2. The assembly according to claim 1, wherein said frame comprises a plurality of basal members each being coupled together and intersecting each other at right angles such that said basal members defines a rectangular shape, said plurality of basal members including a front basal member, a rear basal member, a first lateral basal member and a second lateral basal member.

3. The assembly according to claim 2, wherein said frame includes a central member extending between each of said first lateral basal member and said second lateral basal member, said central member being centrally positioned between said front basal member and said rear basal member.

4. The assembly according to claim 2, wherein said frame includes a pair of upright members, each of said upright members being coupled to and extending upwardly from said rear basal member, each of said upright members being aligned with opposite ends of said rear basal member, each of said upright members having a distal end with respect to said rear basal member.

5. The assembly according to claim 4, wherein said frame includes a top member being coupled to and extending between each of said upright members, said top member intersecting said distal end of each of said upright members, said top member being oriented collinear with said rear basal member.

6. The assembly according to claim 5, wherein said frame includes a pair of side members, each of said side members being coupled between said top member and said front basal member, each of said side members sloping downwardly between said top member and said front basal member, each of said side members being aligned with a respective one of said first lateral basal member and said second lateral basal member.

7. The assembly according to claim 5, wherein said basket comprises a plurality of basket members, each of said basket members having a first end and a second end, each of said basket members having a bend thereon to define a first portion of said basket members forming an angle with a second portion of said basket members, said bend being positioned closer to said first end than said second end, said first end of each of said basket members being coupled to said top member having said first portion of each of said basket members extending downwardly from said top member.

8. The assembly according to claim 7, wherein said second end of each of said basket members is coupled to said front basal member having said second portion of each of said basket members sloping downwardly between said bend and said front basal member, said second portion of each of said basket members being spaced upwardly from the floor of the microwave oven when said frame is positioned in the microwave oven.

9. A cooking rack assembly being configured to elevate food being cooked in a microwave oven, said assembly comprising:
a frame being positionable in a microwave oven, said frame being comprised of a non-metallic material wherein said frame is inhibited from reflecting microwave radiation, said frame comprising:
a plurality of basal members each being coupled together and intersecting each other at right angles such that said basal members defines a rectangular shape, said plurality of basal members including a front basal member, a rear basal member, a first lateral basal member and a second lateral basal member;
a central member extending between each of said first lateral basal member and said second lateral basal member, said central member being centrally positioned between said front basal member and said rear basal member;
a pair of upright members, each of said upright members being coupled to and extending upwardly from said rear basal member, each of said upright members being aligned with opposite ends of said rear basal member, each of said upright members having a distal end with respect to said rear basal member;
a top member being coupled to and extending between each of said upright members, said top member intersecting said distal end of each of said upright members, said top member being oriented collinear with said rear basal member; and
a pair of side members, each of said side members being coupled between said top member and said front basal member, each of said side members sloping downwardly between said top member and said front basal member, each of said side members being aligned with a respective one of said first lateral basal member and said second lateral basal member; and
a basket being coupled to said frame, said basket being elevated from a floor of the microwave oven when said frame is positioned in the microwave oven, said basket being comprised of a non-metallic material wherein said basket is inhibited from reflecting microwave radiation, said basket having a food item being positionable thereon wherein said basket is configured to facilitate the foot item to heat evenly in the microwave oven, said basket comprising a plurality of basket members, each of said basket members having a first end and a second end, each of said basket members having a bend thereon to define a first portion of said basket members forming an angle with a second portion of said basket members, said bend being positioned closer to said first end than said second end, said first end of each of said basket members being coupled to said top member having said first portion of each of said basket members extending downwardly from said top member, said second end of each of said basket members being coupled to said front basal member having said second portion of each of said basket members sloping downwardly between said bend and said front basal member, said second portion of each of said basket members being spaced upwardly from the floor of the microwave oven when said frame is positioned in the microwave oven.
